(19) United States
(12) Patent Application Publication
(10) Pub. No.: US 2016/0230028 A1
(43) Pub. Date: Aug. 11, 2016

(54) ADJUSTMENT OF THE PROPERTIES OF A RETINAL PROTEIN IN A PHOTOCHROMIC PRODUCT

(71) Applicant: ACTILOR INTELLECTUAL ASSET AG, Malans (CH)

(72) Inventors: Ulrich RITTER, Nidda-Schwickartshausen (DE); Samuel SCHINDLER, Grusch (CH); Geza MURVAI, Leipzig (DE)

(73) Assignee: ACTILOR INTELLECTUAL ASSET AG, Malans (CH)

(21) Appl. No.: 14/917,809

(22) PCT Filed: Aug. 26, 2014
(86) PCT No.: PCT/EP2014/068097

§ 371 Date: Mar. 9, 2016

(30) Foreign Application Priority Data
Sep. 10, 2013 (CH) 01551/13

(51) Int. Cl. C09D 11/04; B42D 25/24; B42D 25/378; B42D 25/29; B42D 25/23; C09D 11/50; B42D 25/25

(52) U.S. Cl. CPC C09D 11/04; C09D 11/50; B42D 25/24; B42D 25/25; B42D 25/29; B42D 25/23; B42D 25/378

(57) ABSTRACT

A product having a substrate and a color application applied thereto is specified. The color application comprises, in each of a first area element and a second area element, at least one color layer (32) comprising a retinal protein which shows a color change when illuminated. Present in at least one of the area elements is a functional layer (33, 33′) which alters the proton availability for the retinal protein in the area element in question, such that the color change of the retinal protein in the first area element and in the second area element shows a different time dependence and/or light sensitivity.

### TECHNICAL FIELD

The present invention relates to a product with a color application which comprises a retinal protein, in particular bacteriorhodopsin, wherein the retinal protein exhibits a light-induced color change on illumination with light of suitable wavelength composition (photochromism). In addition, the invention relates to a security-related product comprising such a product and a production process for such a product.

### PRIOR ART

During and/or after illumination with light of suitable wavelength composition, photochromic materials exhibit a light-induced color change. Depending on the material, on the given chemical conditions and the spectral irradiation density or radiation intensity, the color change typically takes place within milliseconds to a few seconds. After the end of the illumination, many photochromic materials revert to the starting color by thermal relaxation, mostly within milliseconds to hours. This relaxation process can often be accelerated by irradiation with suitable light.

From the prior art, a large number of synthetic photochromic materials are known. However, many synthetic photochromic materials have a tendency to thermal and photochemical degradation because of their high reactivity, or to a chemical change such as a rearrangement, ring opening, etc. because of their low thermodynamic stability. As a result, they have a relatively low cycle number to loss of function. In addition, many photochromic materials are only switchable with UV or near-UV light.

Photochromic materials based on retinal proteins have also become known, some of which have also been produced biochemically. An especially well studied photochromic system is based on the membrane protein bacteriorhodopsin (BR), which can be obtained from the extremophile organism Halobacterium salinarum. The BR system is the subject of a whole range of patent documents, e.g.: EP-A-0 406 850, EP-A-0 487 099, EP-A-0 655 162, EP-A-0 532 029, EP-A-1 459 301, WO-A-00/59731, WO-A-03/052701, WO-A-00/58450 and WO-A-2010/124908.

In membrane-bound form, retinal proteins such as BR mostly act as proton pumps. It is known that the color change properties of retinal proteins, in particular the light sensitivity and the kinetics of the color change, depend on the proton availability for the membrane-bound retinal molecule.

Photochromic materials based on retinal proteins are particularly useful for use as security features for ensuring authenticity, for serialization or individualization, in particular with regard to the prevention of counterfeiting of documents or objects, since the characteristic color change can only be reproduced or imitated with difficulty. However, the color change is in a way only a one-dimensional feature. It is therefore desirable to modify products based on retinal proteins such that they exhibit further characteristic properties which are not easy to imitate, in order thus to improve the security of security features based thereon. Even with purely decorative use of photochromic materials, it is desirable to place further attractive features alongside the simple color change.

### SUMMARY OF THE INVENTION

The present invention provides a product which has a substrate and a color application applied thereon. In each of a first and a second surface element, the color application has at least one color layer comprising a retinal protein which exhibits a color change on illumination. According to the invention at least one functional layer is present in at least one of the surface elements, which alters the proton availability for the retinal protein in the surface element concerned, so that the color change of the retinal protein in the first and in the second surface element under the same environmental conditions displays a different time dependence and/or light sensitivity.

Thus the color application displays a light-induced color change (photochromism) during or after illumination. This color change is preferably perceptible with the naked, i.e. unaided eye. The kinetics and/or sensitivity of the color change is spatially modulated by the functional layer, in that the functional layer modulates the proton availability. Therefore, beyond the mere presence or absence of the color change, the product also acquires a further feature, namely a spatial modulation of the time dependence or sensitivity of the color change. Different surface elements of the product thus exhibit the color change with different time constants or sensitivities. In this manner, a further dimension as it were created, which makes the product unique beyond the mere presence of the color change. Thus the layout of a banknote for example can be configured such that the numeral of the note value and a portrait on the banknote can change from violet to yellow on exposure to light, and that after dimming, the coloring of the numeral reverts to violet relatively slowly, while the coloring of the portrait reverts to violet more rapidly. Since the modulation of the time dependence or sensitivity takes place via a separate functional layer, only a single formulation of the color change pigment needs to be supplied during the production of the product of the present invention. This is especially advantageous since the production of the formulation of the color change pigment is as a rule relatively costly, while the functional layers are as a rule easier to produce.

Preferably, a color change which occurs in the first and second surface element between essentially the same color values is involved. Preferably, the visual effect in the first and second surface element essentially differs only by its time dependence and/or light sensitivity, while all other optically readily perceptible characteristics such as for example the color values involved in the first and second surface element are essentially the same. As already mentioned, the first and the second surface element preferably even comprise the same formulation of the retinal protein. A retinal protein of the aforesaid type is an example of a color change pigment, reference is therefore sometimes made below in general to color change pigments.

The color application can consist of a single layer or comprise several layers. Apart from one or more layers comprising the retinal protein and one or more functional layers for altering the proton availability, the color application can comprise further functional layers, e.g. magnetic or electrically conducting layers, primer layers, parting layers, protective layers and/or covering layers such as lacquer layers etc. and/or one or more further color layers of a “normal” printing ink which generates no color change, and/or one or more further color layers of a printing ink which generates a temporally variable visual effect different from a color change, e.g. phosphorescence. Such layers can be present over a whole area or only part of an area.

The color application can be applied onto the substrate by any printing or coating method, in particular printed, rolled, transferred, poured, sprayed or otherwise. In this, the printing ink generating the temporally variable effect can for example be applied as a high viscosity compound, as dry substance, as a color system, as a lacquer system, coating system, etc. The term “printing ink” should however be understood as a generic term, which is not to be interpreted as limiting for the application method. Alternatively, the term “ink” is also sometimes used below as a synonym.

The color change preferably occurs during or after illumination with light in the visible wavelength range (ca. 380 to 750 nm). Preferably, the color change occurs both in the first and also in the second surface element with a time dependence which is directly perceptible by the human eye, in particular with a characteristic time constant of 0.5 seconds to 30 seconds. As a result, the product is especially suitable for use as a so-called level 1 security feature (low security feature), i.e. as a security feature which can be perceived with the naked eye.

However, for other use purposes, e.g. optical data storage, it is also possible that the color change occurs at least in one of the two surface elements with a time dependence which is faster than can be perceived with the naked human eye. In general terms, the characteristic time constant for the color change both in the first and also in the second surface element preferably lies between 5 milliseconds and 60 seconds. Preferably, the characteristic time constants in the first and second surface element are in a ratio of at least 1.2, preferably at least 2.0. If the color change is to be perceptible to the naked human eye, the time constants preferably differ in absolute terms by at least 0.5 seconds.

The characteristic time constant can be defined as follows: if the visual effect is based on the transition of a population of chromophores from an initial state (e.g. starting color) to a final state (e.g. final color), the time constant is that time in which the population P(t) of the initial state has fallen to a factor 1/c of the initial value P₀. In the case of a monoexponential time dependence of the population difference, the characteristic time constant τ corresponds exactly to the reciprocal of the transition rate γ:

P(t)=P₀ exp(−γt), where γ=1/τ.

Preferably, the retinal protein is membrane-bound bacteriorhodopsin of the wild type (BR-WT) or a membrane-bound bacteriorhodopsin variant. The term “bacteriorhodopsin variant” comprises BR molecules which differ from BR-WT by addition, substitution, deletion and/or insertion of amino acids, in particular of at least one and up to 50, preferably up to 20, and especially preferably up to 10 amino acids. A preferred BR variant is in particular the mutant BR-D96N. Furthermore, BR molecules whose retinal is replaced by molecules analogous to retinal, and BR molecules which have been chemically modified, e.g. by introduction of protective groups or functional side groups, or which have been crosslinked together, also fall within the term “bacteriorhodopsin variant”.

In order to influence the proton availability for the retinal protein, the functional layer in the first and second surface element can for example comprise different concentrations of proton donors or acceptors and/or have a different water content. In order to permit influencing of the retinal protein, both the color layer and also the functional layer should be selected such that proton transport remains possible, e.g. by forming continuous hydrogen bridge systems between retinal protein and functional layer. In particular, the retinal protein should not be present fully encapsulated, but should still be accessible for proton transport.

The formulation of the retinal protein is preferably constituted as follows in order to ensure that the proton availability of the retinal protein can be modulated by a neighboring layer: retinal protein in powder form, film-forming binder, preferably acrylate-based or polyurethane-based, as a physically drying or UV-curable dispersion or as a UV-curable 100% system, surfactants, hygroscopic additives, acidic and/or alkaline and/or amphoteric additives in a quantity ratio which forms a buffer system in dilute aqueous solution, optionally further colorants, and optionally further additives such as light stabilizers, rheological additives and/or bio stabilizers.

As functional layers for modulating the proton availability of the retinal protein, the following are for example possible: layers of a formulation with markedly different pH-value than the color layer (in each case before drying) or layers comprising water-retaining or hygroscopic substances.

As substances which influence the pH-value in the formulation and thus the proton availability in the functional layer, the following may be non-exhaustively mentioned: buffer systems such as TRIS/HC1 (comprising TRIS: tris(hydroxymethyl)-aminomethane), the ampholytic buffers HEPES (4-(2-hydroxyethyl)-1-piperazinethanesulfonic acid), HEPPS (4-(2-hydroxyethyl)-piperazin-l-propanesulfonic acid), MES (brand name PUFFERAN™ equals 2-(N-morpholino)ethanesulfonic acid), amino acids or Na₂HPO₄/NaH₂PO₄ or ion exchange resins such as LEWATIT™ (from Lanxess), Dowex™ (from Dow Chemicals) or Amberlite™ (from Rohm and Haas). A whole range of further substances influencing the pH-value are known to those skilled in the art and are common prior art.

As examples of water-retaining or hygroscopic substances, the following may be non-exhaustively mentioned: salts retaining water of crystallization such as lithium and potassium salts (in particular halides or phosphates thereof), polyalcohols (also partially modified polyalcohols such as partially esterified polyalcohols), wherein such substances bind water loosely by swelling and by hydrogen bridges, oligo alcohols such as sugars or sugar alcohols (e.g. xylitol, sorbitol), wherein these substances take up water loosely by hydrogen bridges, polydextroses, glycerin, low molecular or polymeric glycols (such as 1,2-propanediol), superabsorbers, zeolites, silicates such as for example magnesium silicates, and organic resins modified with acidic or basic groups, such as ion exchange resins.

Such substances can be bound by a film-forming agent which as a matrix immobilizes the substance concerned. Possible film-forming agents are for example: aqueous acrylate dispersions, aqueous polyurethane dispersions, UV-curable acrylate resins and oxidatively drying alkyd resins. Further additives such as surfactants, dispersants and/or rheological additives and further auxiliary agents such as dyes, pigments, UV stabilizers and/or biostabilizers can be added.

In some embodiments, the functional layer can be designed to alter the proton availability for the retinal protein in at least one of the surface elements depending on a chemical environment of the product. In other words, the functional layer in such embodiments acts as a kind of chemical sensor layer, which perceives certain environmental conditions and depending on these adjusts the proton availability. The color layer then serves as a kind of indicator layer for this chemical environment. In particular, the functional layer can be designed to adjust the proton availability for the retinal protein depending on the pH-value of the environment. In the simplest case, the functional layer for this is a porous, but otherwise inert layer, which allows the color layer to be directly influenced by the pH-value of the environment.

In order to achieve a different modulation, the first and the second surface element can have different thicknesses or numbers of functional layers which alter the proton availability for the retinal protein. In particular it is possible that such a functional layer is present in only one of the surface elements (e.g. the first surface element), while it is absent in the other of the surface elements (e.g. the second surface element).

In some embodiments, in at least one of the surface elements the relevant functional layer is arranged between the substrate and the at least one color layer. In other embodiments, in at least one of the surface elements the relevant functional layer is arranged on the side of the at least one color layer facing away from the substrate. In still other embodiments, in at least one of the surface elements a relevant functional layer is arranged both between the substrate and the at least one color layer and also on the side of the at least one color layer facing away from the substrate. “Relevant” here means that the functional layer modulates the proton availability for the retinal protein.

An additional spatial modulation of the time dependence can be achieved in that in the first and second surface element the same printing ink is present in the form of a formulation of the retinal protein, wherein the printing ink in the first and second surface element has a different layer thickness. The term “layer thickness” relates to the dimension perpendicular to the substrate surface. With printing inks with color change pigments based on retinal proteins it was surprisingly observed that the color change during the illumination, but to some extent also during the relaxation after the end of the illumination, often occurs more rapidly in the highest-lying (i.e. most distant from substrate) regions and proceeds markedly more slowly in the regions lying lower down (close to substrate). This can in particular occur if the printing ink is chemically influenced by the substrate lying under it or a functional layer lying under it, in that it alters the proton availability for the retinal protein in the direct chemical environment of the retinal protein. In this case, as a rule those regions of the printing ink which lie closer to the substrate or to the functional layer are more strongly influenced than regions lying further away from it. In this manner, a thicker layer of the printing ink overall exhibits a different time dependence from a thinner layer. A different coating thickness of the printing ink can however also lead to a modulation of the time dependence in that regions of the color application lying closer to the light source (i.e. regions further from the substrate) on the basis of their own color changes influence the regions lying under them (closer to substrate), since on the basis of their own time dependence they act as a time-dependent filter for the illumination. A further reason for the color change behavior of thicker layers in comparison to thinner layers consists in that in the greater volume of thicker layers more retinal protein complexes are present which can be excited to a color change, which manifests itself in more sluggish switching behavior.

Surface elements of the same printing ink of different thickness can for example be generated by applying a different number of layers of the printing ink in different regions of the product, e.g. a number n in the first region and a number m in the second region, wherein n and m are different natural numbers. This can however also be achieved by applying the printing ink in a single pass with different layer thicknesses in different regions, e.g. in an intaglio printing process, in which different regions of the printing plate have depressions (gravures) produced with different depths.

Here it is preferable that the product is a printed product which has been produced in the intaglio printing process. The characteristics of such a printed product are readily ascertainable to those skilled in the art. In particular, the surface elements which are generated by the printing in the case of intaglio printing are embossed linearly and in relief. Since intaglio printing makes a greatly variable coating thickness possible, and since several layers can be applied with consecutively connected printing units, a very large scope for spatial variation of the time dependence on the resulting printed product is obtained. Preferably, the printing ink for the intaglio printing is a formulation based on a water-dilutable, acrylic binder system, and/or based on a binder curable by a polymerization, in particular based on a thermally or UV light-initiated radical curing binder, or based on alkyd resin, preferably solvent-free long oil alkyl resin, whose polymerization is triggered by atmospheric oxygen.

The intaglio printing process is capable of reproducing the printed motifs with very good edge definition. As a result, fine lines or hatching can be reproduced in the intaglio printing process with particularly high clarity. Also, in comparison to other printing processes, high superpositions can be achieved with intaglio. Sharp-edged lines, which start fine and then become broader and at the same time thicker-layered, are thus only possible in intaglio printing. Such lines exhibit a different color change behavior in their fine regions than in the broad and thick-layered regions.

A product, which can thus only be obtained by intaglio printing, is obtained when two consecutive inking units partially print over one another, when for example in a first intaglio inking unit a “/” and in a second inking unit a “\” is printed, so that overall a composite “X” is obtained. The renewed stamping of the already previously deformed substrate, together with the high edge definition of the intaglio printing process results in a characteristic image at the site of the crossing lines, in a manner that only intaglio printing is able to reproduce. The pressing of the first printed line by the subsequent printing decreases the layer thickness of the first printed line and thereby alters the switching behavior of the first printed line, so that the color change of the first printed line differs from that of the line lying over it. In other words, therefore, a product is proposed in which the first and the second surface element are generated in the intaglio process, and are the result of at least two part printings. In each part printing, a color layer arranged in lines is applied, wherein selected lines of different part printings cross or overlap. A region of one line in which this line crosses or overlaps no other line can then be regarded as a first surface element. A region in which at least two lines cross or overlap can be regarded as a second surface element. Because of the characteristic features of intaglio printing, at least one of the color layers in the second surface element (more precisely: the lower color layer) can then be reduced in its thickness compared to the same color layer in the first surface element.

An additional spatial modulation of the time dependence can also be achieved through the first and the second surface element having the same printing ink, and the first and the second surface element having the same thickness, but different width (the term “width” relates to one of the two dimensions parallel to the substrate surface). The reason is firstly that several narrow surface elements which are separated from one another by a gravure groove have more side surfaces than a few broad surface elements and hence offer a greater area of action for irradiation, and secondly that diagonally incident light in different regions of the color application must pass through different layer thicknesses down to the substrate or down to the layer lying under the printing ink. Thus the corresponding path length in regions close to the edge is shorter than in regions far from the edge. If the line width is of the order of magnitude of the particular layer thickness, then with diagonally incident light an edge effect becomes visible: the path of the light through the light-induced color-changing printing ink with an incidence angle of for example 45° to the normal to the substrate surface is longer by the factor 1.4 (more precisely: by the factor \sqrt{2}) in regions far from the edge, so that there the layer behaves like a layer of 1.4 times the thickness with vertical light incidence. However, in regions close to the edge, this path is markedly less. Thus the visual effect in a narrow surface element can occur faster overall than in a wider surface element, when regions close to the edge exhibit a faster time dependence than regions far from the edge. In the end, as a result of this a similar effect arises as in the case of a color application of different thicknesses.

In addition to a functional layer which modulates the proton availability, a further functional layer can also be provided, which influences the color layer by physical means, in that it influences the light intensity received by the color layer, at least in a part region of the visible wavelength spectrum, e.g. in that it acts as a wavelength-dependent filter. As a further functional layer, a primer layer or another kind of functional layer can also be provided, which is provided between the substrate and the color layer. However, it can also be a functional, transparent or partly transparent covering layer, e.g. a spot coating, which is provided on the side of the color layer facing away from the substrate. A spot coating is understood to be an additional gloss coating which gives the impression of a metallic surface. Such a spot coating is for example usual in the title pages of special interest magazines from the automotive, photography and phono fields, etc., in order to convey the impression of metallic paints. Such a spot coating layer is very clearly recognizable in the diagonal light. Of course it is also possible that functional layers are present both on the side of the color layer close to the substrate and also on that facing away from the substrate.

Of course, the modulation of the time dependence and/or sensitivity of the color change can also be achieved by a combination of the above measures.

An especially striking effect can be produced by allowing the color change to “migrate” over the product or by creating the impression of an animation. For this, the color change in the first surface element exhibits a first time dependence, and the color change in the second surface element exhibits a second time dependence. The color application additionally comprises at least one third surface element, in which the color change takes place with a third time dependence. The time dependences become slower from the first via the second down to the third surface element. More precisely expressed, the first time dependence exhibits a first characteristic time constant, the second time dependence exhibits a second characteristic time constant, and the third time dependence exhibits a third characteristic time constant, wherein the third characteristic time constant is greater than the second characteristic time constant and the second characteristic time constant is greater than the first characteristic time constant. The first, second and third surface element are spatially arranged relative to one another such that on illumination the impression is given of a visual effect or color change migrating from the first via the second on to the third surface element. For this, it is preferable that the first, second and third surface element are arranged one after another along a (straight or crooked) line. In particular, it is preferable that the second surface element follows on the first surface element directly or at a relatively small distance, and that the third region follows on the first surface element directly or at a relatively small distance. Of course, more than three surface elements with different time dependences can also be present and optionally arranged in this manner. Likewise, it is possible that the time dependence changes continuously right across the product, so that there are no sharply separated surface elements whatsoever. It is also possible that two surface elements exhibit an indefinite or even randomly altered boundary and hence exhibit a characteristic variation of the time dependence. A boundary between two color applications changing randomly or erratically from use to use is regarded in security printing as an individual security feature comparable to a fingerprint (rainbow printing).

The total layer thickness of the color layer which generates the color change preferably lies in the region between 2 micrometers and 200 micrometers, particularly preferably in the region between 10 micrometers and 120 micrometers. More precisely expressed, the color application preferably has at least one color layer with a printing ink which during or after illumination generates a color change, wherein this color layer has a thickness between 2 micrometers and 150 micrometers, particularly preferably between 5 micrometers and 75 micrometers.

The first and second surface element (as also if appropriate, further surface elements), in which the temporally variable visual effect occurs, preferably form parts of a motif or themselves have the form of a motif. The motif can be for example symbols, letters, pictures, photos, samples, guilloche motifs, numberings or combinations of such elements.

The product according to the invention can in particular be used as a security element. This can serve to confirm the authenticity of a product or to individualize a product, i.e. to confirm the authenticity and identity of the product. Accordingly, the present invention also relates to a security-related product which has a security element in the form of a product of the aforesaid nature. The security-related product can in particular be a product of the following nature: identification papers, passports, ID cards, visas, banknotes, tax stamps, postage stamps, stock certificates, tickets, seals, forms, labels for product identification, labels for brand identification, laminating films, transfer films, stamps, thin films, overlay films, driving licenses and birth certificates.

In addition, the invention provides a process for the production of a product, comprising:
application of a color application onto a substrate, wherein the color application in each of a first and in a second surface element has at least one color layer comprising a retinal protein which exhibits a color change on illumination,
wherein in at least one of the surface elements before and/or after the color application at least one functional layer is applied which alters the proton availability for the retinal protein in the surface element concerned, so that the color change of the retinal protein in the first and in the second surface element exhibits a different time dependence and/or light sensitivity.

Also, it is preferable that in the first and second surface element the same formulation of the retinal protein is applied.

The application of the color application and/or the functional layer can in particular be effected with one of the following processes: gravure printing (in particular intaglio printing), screen printing, inkjet printing, waterless offset, flexographic printing and letterpress.

Furthermore, the above observations regarding particular configurations of the product likewise also apply for corresponding processes for the production of a corresponding product.

### BRIEF DESCRIPTION OF THE DRAWINGS

The invention is explained in more detail below on the basis of the drawings, wherein the drawings serve only for illustration and are not to be interpreted as limiting. In the drawings:

FIG. 1 shows a schematic diagram of the application of a printing ink by intaglio printing;

FIG. 2 a schematic diagram of the resulting printed product;

FIG. 3 diagrams of the color change behavior of the color application in the product of FIG. 2; part (a) illustrates a state at a time point t₁, part (b) illustrates the state at a later time point t₂>t₁;

FIG. 4 diagrams of the dependence of the color change behavior on the thickness of the color application with the same width x of the color application; part (a) illustrates the color change for a thickness y, part (b) for a greater thickness z>y;

FIG. 5 diagrams of the dependence of the color change behavior on the width of the color application with the same thickness y of the color application; part (a) illustrates the color change for a width x, part (b) for a width of somewhat less than x/2;

FIG. 6 Diagrams of the dependence of the color change behavior on the formulation; part (a) illustrates the color change behavior for a surface element consisting of two sublayers, which each have a thickness y, wherein the first sublayer comprises a formulation BR1 and the second sublayer a formulation BR2; part (b) illustrates the color change behavior for a surface element of thickness z=2y, wherein the surface element is formed by a single layer of the formulation BR1;

FIG. 7 diagrams of the color change behavior for two surface elements which differ both in their thickness and also in their composition;

FIG. 8 diagrams of the dependence of the color change behavior on the layer order; part (a) shows a two-layer surface element, the lower layer thereof comprises a formulation BR1 and the upper layer thereof a formulation BR2; part (b) illustrates such a surface element with the reverse layer order;

FIG. 9 diagrams to illustrate how a migrating visual effect can be achieved by a linear arrangement of planer elements with different time constants;

FIG. 10 diagrams of printed products in which a color application is applied with different thicknesses directly onto a substrate (part (a)) or onto a substrate with primer layer (part (b));

FIG. 11 diagrams of layer structures of two layers of the same printing ink, wherein the lower layer is either applied directly onto the substrate (part (a)) or onto a primer layer (part (a));

FIG. 12 diagrams of layer structures in which a BR-comprising color layer is in some regions provided with a covering layer, wherein the BR-comprising color layer is either directly applied onto the substrate (part (a)) or is applied onto a primer layer (part (b));

FIG. 13 diagrams of layer structures in which different primer layers modulating the proton availability have been applied onto a substrate in different regions, and then a BR-comprising color layer has been applied onto this; in part (a) no further covering layer is provided, while in part (b) such a covering layer is additionally present;

FIG. 14 diagrams of layer structures in which two different BR-comprising formulations have been applied onto a continuous primer layer; in part (a) no further covering layer is provided, while in part (b) such a covering layer is additionally present;

FIG. 15 diagrams of layer structures in which a BR-comprising layer has been applied onto a whole or part area functional layer which chemically influences the BR-comprising layer, wherein the BR-comprising layer is optionally followed by a covering layer;

FIG. 16 diagrams of selected layer structures as in FIG. 15, wherein a primer layer is additionally provided between the substrate and the functional layer;

FIG. 17 diagrams of layer structures in which a BR-comprising layer is arranged between two functional layers which chemically influence the BR-comprising layer, wherein optionally a primer layer or a covering layer is present;

FIG. 18 diagrams of layer structures in which a BR-comprising layer is arranged between two functional layers which chemically influence the BR-comprising layer, and in which on the one hand a primer layer is arranged between the substrate and the lower functional layer and a covering layer is arranged on the upper functional layer; and

FIG. 19 an illustration of a bleaching process in a color application with layers of different thickness.

### DESCRIPTION OF PREFERRED EMBODIMENTS

Intaglio Printing

In intaglio printing, a printing plate, often a printing cylinder, which is provided with linear depressions (“gravures”) is used. The printing ink has a relatively high viscosity in comparison to other printing processes. It is firstly applied over the whole area of the printing plate and then wiped off in the regions outside the gravures. The gravures can be mechanically created, but are as a rule produced photochemically or as laser gravure. Typical gravure depths lie in the region 2-150 micrometers, typical gravure widths of the order of magnitude of the gravure depth. The printing plate is pressed onto the substrate under high pressure (typically 5 to 100 metric tons) and often at elevated temperature (typically up to 80° C.). The substrate can be paper, but other types of substrates such as for example plastic films can also be used.

Intaglio printing as a gravure printing process based on linear gravures has long been known from the prior art, and a detailed description of the characteristic features of this printing process will not be given here. Since in comparison to other common printing processes intaglio printing is relatively costly, it is mainly used for the production of value-bearing or security-related printed products, such as for example securities, ID cards, tax stamps, postage stamps, banknotes, stock certificates, identification documents such as travel passports or visas, credit cards, lottery tickets etc.

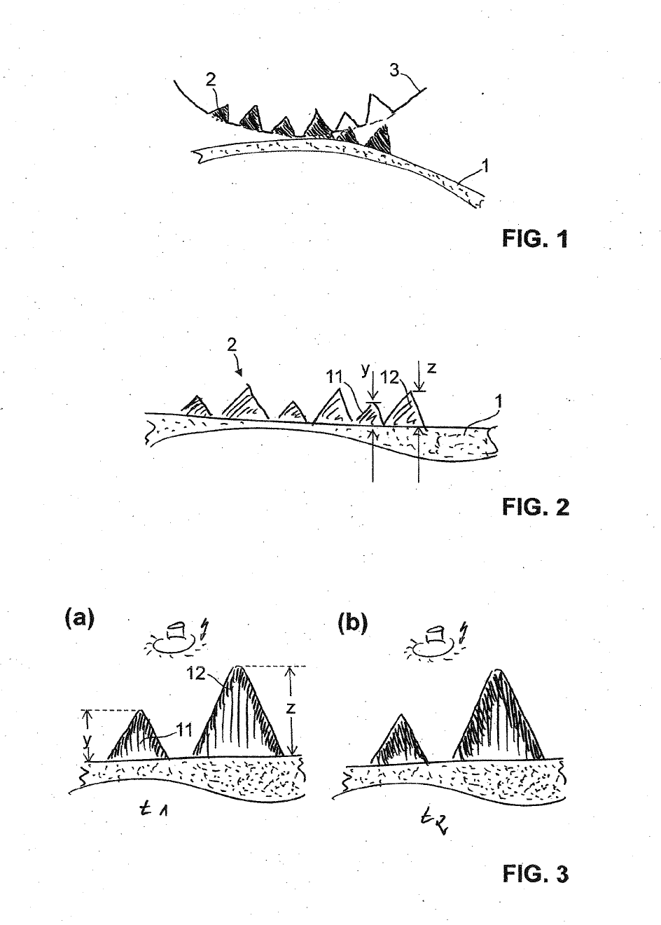

FIG. 1 illustrates by way of example and only very schematically how a printing ink 2 is applied onto a substrate 1 by intaglio printing. An intaglio printing cylinder 3 has linear gravures of different depth and optionally also different width, which are filled with the printing ink 2. Through the printing process, the printing ink 2 is transferred onto the substrate 1.

The resulting printed product is illustrated in FIG. 2. The printed application has an embossed structure of variable layer thickness, depending on the depth of the gravures in the intaglio printing cylinder. Here inter alia it has two longitudinally extended (linear) surface elements 11, 12 of printing ink with different layer thicknesses y and z respectively.

In particular, these surface elements can be formed of a retinal protein-comprising, in particular BR-comprising printing ink, which on illumination with suitable light exhibits a color change behavior. As is illustrated in FIG. 3, it was surprisingly found that in this case the surface elements 11, 12 of differing thickness differ not only in their intensity, but also in the kinetics of their color change behavior on illumination. Here, lightly hatched regions exhibit the ground state (B and/or D state) of the BR (violet), while darkly hatched regions exhibit the bleached state of the BR (yellow). In the surface element 11 with the lower thickness y, the color change overall takes place more rapidly than in the surface element 12 with the greater thickness z, since regions of the surface elements lying above and facing away from the substrate are bleached more rapidly than regions lying deeper, and close to the substrate. After a time t₁, at which the surface element 11 is already ca. 50% bleached, the surface element 12 is only bleached by a far lower percentage (part (a)). At a later time-point t₂, at which the surface element 11 is almost completely bleached, the surface element 12 is only ca. 50% bleached (part (b)). Thus under the same illumination conditions and the same environmental conditions, the two surface elements admittedly exhibit the same temporally variable optical effect (namely a delayed color change from violet to yellow), but this takes place with different time dependences in the two surface elements.

This spatial modulation of the time dependence can be especially well and specifically achieved with the intaglio printing process, since in particular the intaglio printing enables large layer thicknesses. As a result, surface elements of the resulting printed product of different thickness have different characteristic time constants for a delayed color change on illumination.

In addition, it was surprisingly observed that the time constant for the relaxation (i.e. for the thermally induced color change from yellow back to violet) also depends on the thickness of the surface elements.

Examples of Achievement of Different Time Dependences in Different Surface Elements

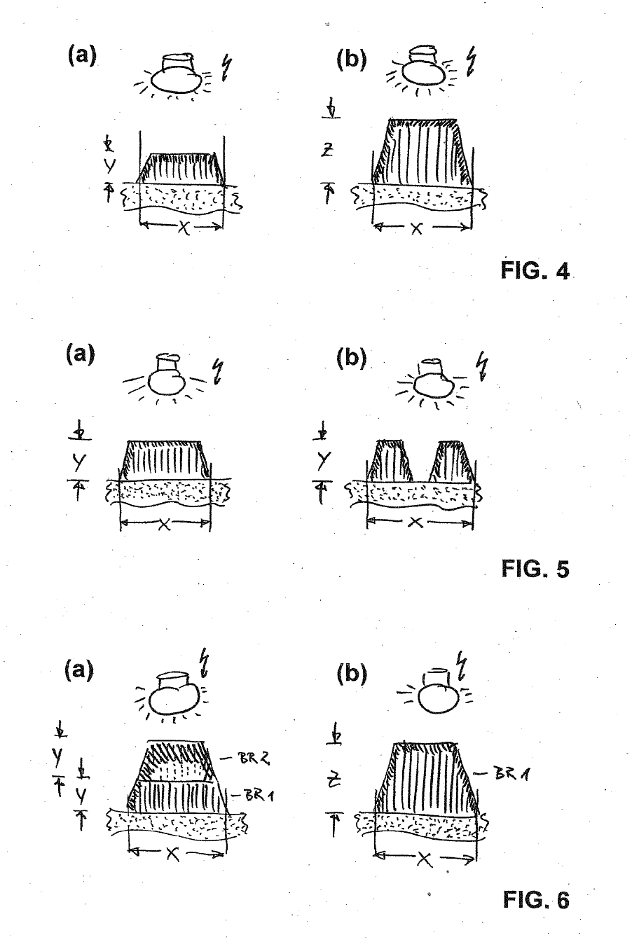

A variation of the time dependence of the color change can be achieved not only by variation of the thickness of the surface elements, but also in various other ways. Some such possibilities are illustrated by way of example in FIGS. 4-8.

A first possibility is illustrated in FIG. 4. As already mentioned, this possibility consists in providing surface elements of different layer thickness (here y and z>y respectively) in different regions of the product.

A second possibility is illustrated in FIG. 5. This possibility consists in providing surface elements of equal layer thickness (here layer thickness y), but different width (here width x and somewhat less than x/2 respectively). As FIG. 5 illustrates, the color change takes place in the lateral edge regions of each surface element more rapidly than in the central regions of the surface element far from the edge. With surface elements of lesser width, as in FIG. 5(b), the color change therefore takes place on average over the whole surface element overall more rapidly than with surface elements of greater width, as in FIG. 5(a). This effect is especially noticeable with diagonally incident light. It is especially pronounced when the width and layer thickness of the surface elements are similar, in particular when the ratio between the width and layer thickness of the surface elements lies between ca. 0.1 and 10, preferably between 0.2 and 5. Expressed in absolute numerical values, the effect is especially pronounced when the layer thickness of the surface elements is at most 50 micrometers and the width at most 500 micrometers.

FIG. 6 illustrates that surface elements of equal dimensions (here width x, layer thickness z=2y) can exhibit different time dependences of the color change behavior, in that at least in sublayers different formulations BR1 and BR2 respectively are used, wherein the formulations differ in their time dependences.

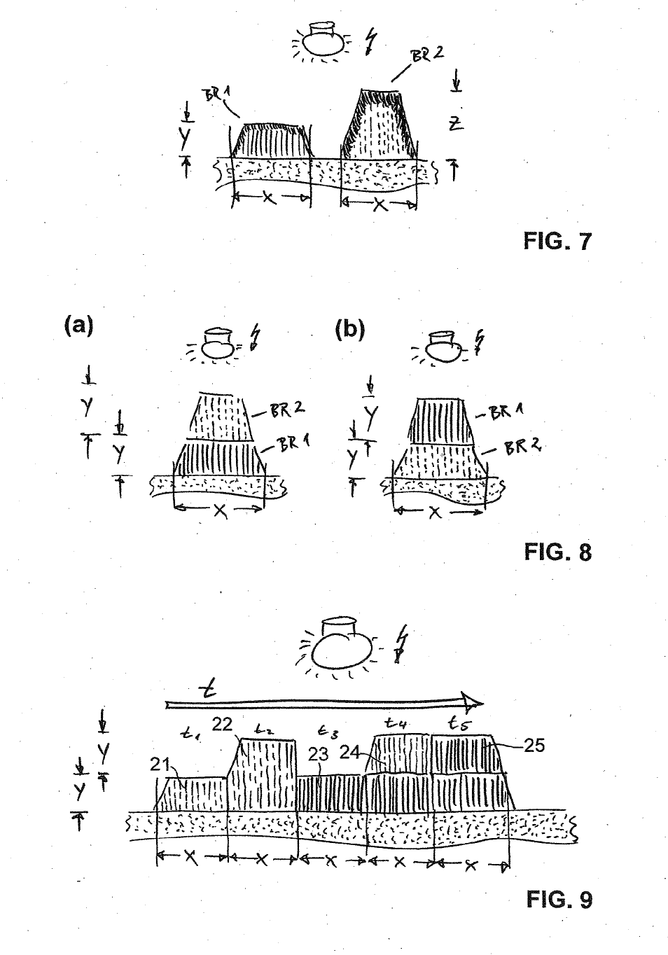

As is shown in FIG. 7, it is of course also possible to apply different surface elements with different layer thickness (here layer thickness y and z respectively) and in addition also different formulations (here BR1 and BR2 respectively), in order to modulate the time dependence of the color change spatially.

A spatial modulation of the color change can also be achieved by creating surface elements with two layers of different BR formulations, wherein the order of these layers differs between the surface elements (FIG. 8). If for example a layer BR2 with more rapid bleaching behavior is arranged over a layer BR1 with slower bleaching behavior, as in FIG. 8(a), the color change overall appears more rapidly than with a reverse arrangement (FIG. 8(b), provided that the upper layer is not very translucent.

“Migrating” Time Dependence or Animation

FIG. 9 illustrates by way of example how surface elements which have different characteristic time constants for the color change can be arranged in such a manner that the impression is given that the color change migrates away spatially over the printed product. For this, a layer of a formulation BR2 with layer thickness y is applied in a first surface element 21. In a second, adjacent surface element 22 a layer of the same formulation with a layer thickness 2y is applied. In a third surface element 23, adjacent to the second surface element 22, a layer of a formulation BR1 with a markedly slower color change behavior than the formulation BR2 is applied with a layer thickness y. In a fourth surface element 24, adjacent to the third surface element 23, a two-layer structure is applied, wherein the lower layer consists of the second formulation BR1 and the upper layer of the first formulation BR2 and each of these layers has the layer thickness y. In a fifth surface element 25 adjacent to the fourth surface element 24, two layers of the first formulation BR1 of the thickness y are applied. Thus overall, the color change occurs most rapidly in the first surface element 21, and the color change occurs most slowly in the fifth surface element 25, with the characteristic time constant increasing continuously from the first to the fifth surface element. As a result, on illumination, the color change occurs firstly in the first surface element 21, then in the second surface element 22 etc., until finally it occurs last in the fifth surface element 25. Thus overall the impression is given that the color change would migrate on from the first to the fifth surface element. Here it is not necessary that the surface elements are directly adjacent to one another: it suffices that the surface elements are arranged along a (straight or crooked) line. A comparable change of color transitions between two defined printing inks in offset printing is common under the term iris printing.

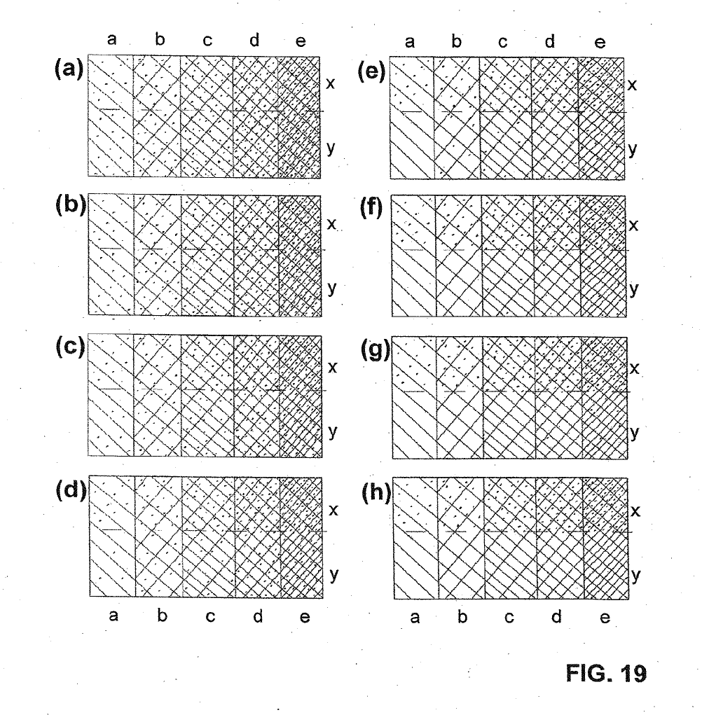

The effect produced is illustrated in FIG. 19. There, the result of a hypothetical bleaching process for a BR-comprising color application with regions a, b, c, d and e with different time constants is illustrated schematically. The different time constants can in particular be achieved by effecting the color application with different layer thickness in said regions. By way of example, the layer thickness can be selected as follows: in the region a there is a first layer thickness D; in the region b the double layer thickness 2D, in the region c the triple layer thickness 3D, in the region d the quadruple layer thickness 4D, and in the region e the quintuple layer thickness 5D. However, there are also other possibilities for adjusting the time constants differently, as was explained in connection with FIG. 9 by way of example. The upper half (region x) of the color application is covered during the bleaching and remains uninfluenced as a reference. The lower half is bleached with light at homogeneous illumination strength. FIG. 19(a) shows the color application before the start of the bleaching process, FIGS. 19(b)-19(g) show the color application after one, two, three etc. units of time, and FIG. 19(h) shows the color application after complete bleaching. The density of the hatching lines indicates the layer thickness, the density of points indicates the intensity of the violet coloration of the region concerned. The region a with single layer thickness is completely bleached first (FIG. 19(e)), followed by region b with doubled layer thickness (FIG. 19(f)), by region c with triple layer thickness (FIG. 19(g)), and finally by the regions of still greater layer thickness (FIG. 19(h)).

By suitable arrangement of such surface elements with different time constants, moving pictures (animations) can also be created.

Examples of Layer Structures

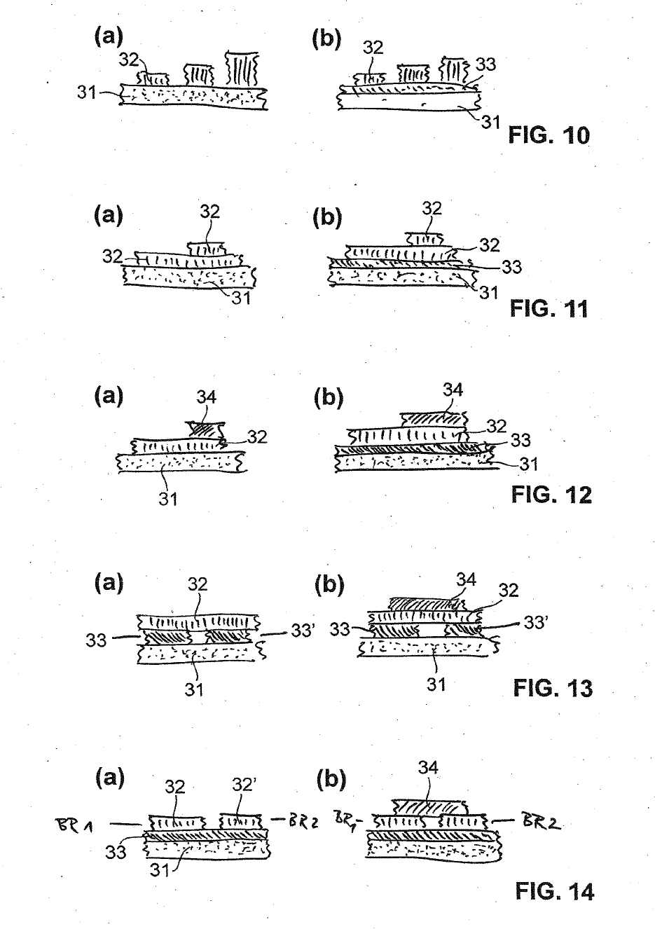

Various possibilities for achieving and specifically adjusting a spatial modulation of the time dependence by means of different layer thicknesses and layer structures are illustrated by way of example in FIGS. 10-18.

In FIG. 10(a), three surface elements of a BR-comprising printing ink 32 of different thickness are applied onto a substrate 31. As explained above, these three surface elements exhibit a different time dependence in their bleaching behavior and optionally also in relaxation behavior. In FIG. 10(b), a primer 33 has additionally been applied onto the substrate. This can for example serve to improve the adhesion of the BR printing ink on the substrate or to improve the surface condition (surface roughness etc.) of the substrate. However, in addition many primers also interact with the PM in the BR printing ink and thereby influence the bleaching behavior and/or the relaxation behavior in the vicinity of the interface between primer and printing ink. As a result, differences in the bleaching and/or relaxation behavior between the surface elements of different thickness are further intensified. In particular, the primer can influence the proton availability for the BR.

In FIG. 11(a), a first layer of the BR-comprising printing ink 32 has been applied onto a substrate 31. A further layer of the same printing ink 32 has been applied onto a partial surface of this layer. In the two-layered regions, a different (slower) color change behavior is observed than in the single-layer regions. By use of a suitable primer 33 (FIG. 11(b)) between substrate and printing ink, this effect can be further enhanced.

In FIG. 12(a), a layer of a BR-comprising printing ink 32 has been applied onto a substrate 31. This layer is partially covered with a partly transparent covering layer 34, e.g. a lacquer layer. The covered regions exhibit a different (slower) color change behavior than the single-layer regions. Once again, a primer 33 can be provided between substrate 31 and printing ink 32 (FIG. 12(b)).

In FIG. 13(a), different primers 33 and 33′ have been applied onto different surface regions of a substrate 31, onto which once again a BR-comprising printing ink 32 has been applied. As was already stated above, the primers 33 and 33′ can influence the proton availability of the BR to a different degree, and as a result alter the kinetics of the color change. In FIG. 13(b), a partly transparent covering layer 34 which additionally modulates the color change behavior has in addition been applied onto the printing ink 32 in some areas.

In FIG. 14(a), a substrate 31 has been provided with a layer of a primer 33. Printing inks 32 and 32′ which comprise different formulations of a PM have been applied onto this in different surface regions. As a result of this, different time dependences result in these part regions. In FIG. 14(b), a partly transparent covering layer 34 which additionally modulates the color change behavior has in addition been applied onto partial surfaces of the two printing ink regions.

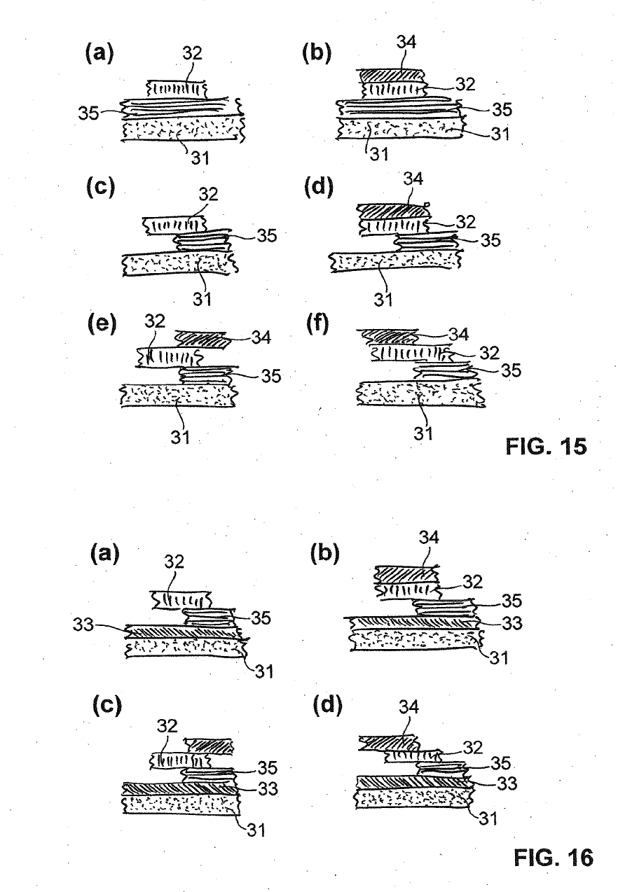

FIG. 15 illustrates various configurations of a layer structure in which a functional layer 35 which serves specifically to influence the kinetics of the color change of the PM in a neighboring PM-comprising layer by modulation of the proton availability has been applied on a substrate 31. A layer of a BR-comprising printing ink 32 has been applied onto this functional layer 35 (part (a)). This can optionally be provided with a covering layer 34 (part (b)). The functional layer 35, the printing ink 32 and the covering layer 34 can also only partly overlap (parts (c)-(f)). In this manner, with only one single BR-comprising printing ink (that is one single formulation of the PM) surface elements with different time dependences can be produced.

In its parts (a)-(d), FIG. 16 illustrates some examples of a layer structure according to FIG. 15, in which however a primer 33 is additionally present between the substrate 31 and the functional layer 35.

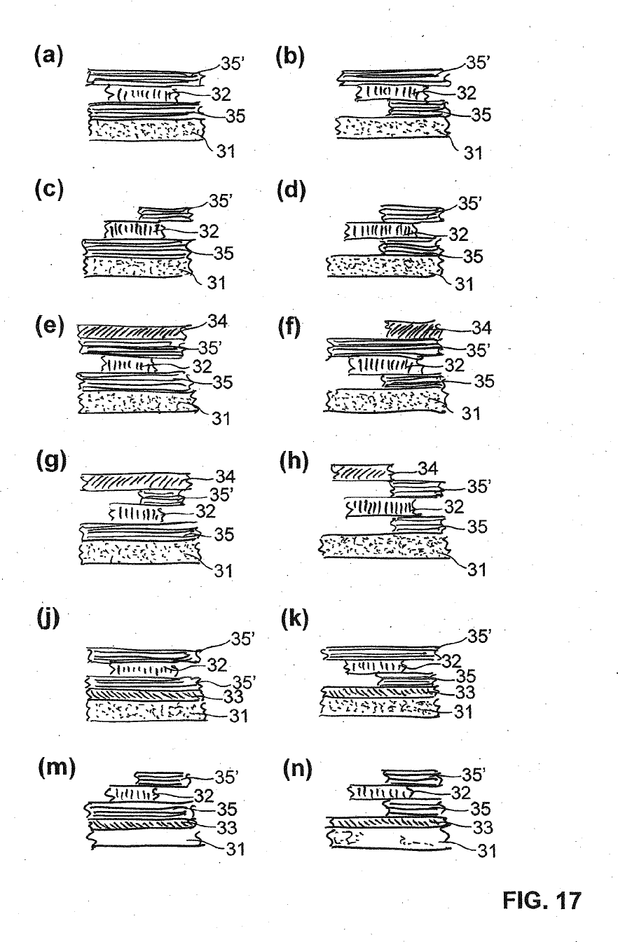

FIG. 17 shows various configurations in which a layer of a BR-comprising printing ink 32 is arranged on both sides all over its surface (parts (a), (e) and (j)) or part of its surface (parts (b)-(d), (f)-(h) and (k)-(n)) between functional layers 35, 35′, in order to modulate the kinetics of the color change of the BR. In addition, a covering layer 34 (parts (e)-(g)) or a primer 33 (parts (j)-(k)) can be present over a whole surface or part of a surface.

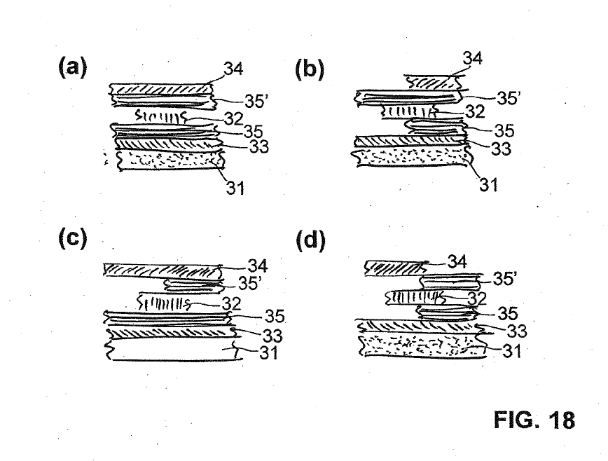

FIG. 18 shows layer structures in which the following layer order is present, wherein the layers only need to overlap partially: substrate 31—primer 33—functional layer 35—printing ink 32—second functional layer 35′—covering layer 34.

Production of a BR-Comprising Printing Ink

Bacteriorhodopsin

The protein component of BR consists of 248 amino acids. In the cell membrane, these form a pore in the shape of seven transmembrane alpha helices. In this pore is located a retinal molecule bound to the protein, which functions as a chromophore. In the cell membrane BR forms hexagonal, two-dimensional crystalline regions with a thickness of ca. 5 nanometers and a side length of up to 5 micrometers, wherein in each case three BR proteins assemble into a trimer. A membrane fragment which comprises such crystalline regions is referred to as purple membrane (PM). The embedding of the BR into the purple membrane results in remarkable stability of the protein to physical and chemical influences. Thus the color and photochemical activity of the PM are maintained even in the presence of oxygen and in the dry state.

In the purple membrane, BR acts as a light-driven proton pump. During this, it passes through a cycle of several, spectroscopically distinguishable states. This sequence of states is referred to as a photocycle. Two particularly characteristic states in the photocycle are the so-called B state, in which the BR exhibits its characteristic red-violet coloration (absorption maximum at ca. 570 nm), and the M state, in which the BR acquires a yellow coloration (absorption maximum at 410 nm). The color change from the B state to the M state can be effected by illumination with white or green light (“bleaching”), while the reversion from the M state to the B state takes place either by a thermal route (relaxation) or photochemically through illumination with blue light.

Influencing of the Kinetics Through the “External” Proton Availability

The kinetics of the photocycle can be influenced in various ways. If the PM is present in an aqueous medium, the kinetics can for example be influenced through the pH-value. If on the other hand the PM is for example present as a layer on a substrate, the kinetics can be influenced through the proton availability of the layer. The proton availability takes the place of the pH, since as is well-known the pH is only defined for dilute aqueous solutions and not for dried layers. More generally expressed, the kinetics of the photocycle can be altered through the “external” proton availability in the environment of the PM. For this, it is possible to add auxiliary substances to a PM preparation which adjust or influence the pH-value in the preparation or which alter the external proton availability in another way. Suitable auxiliary substances are for example glycerin, acetates or compounds which comprises primary or secondary amine groups, e.g. amino acids, in particular arginine, or also in general other hygroscopic or proton-releasing or proton-binding substances (Brønsted acids or bases) and buffer systems which are suitable combinations of acids and bases.

Influencing of the Kinetics by Formation of BR Variants

Various mutations in the amino acid sequence of the protein fraction are known, which markedly slow the kinetics compared to the wild type, in that the “internal” proton availability within the pore is modulated. As a result, both the characteristic time constant for the transition from the B state to the M state on illumination (i.e. the time constant for the “bleaching”) and also the characteristic time constant for the thermally driven relaxation from the M state to the B state (i.e. the “relaxation time”) under normal conditions (room temperature 20° C., pH 7) are brought into a region in which the time component of the color change can be observed with the naked eye (i.e. in the region of ca. 0.5 sec to ca. 30 sec). Particularly well researched mutants with lengthened time constants are for example the mutant D96N, with which the thermal reversion to the violet B state (non-light-induced, proceeding in the dark) under normal conditions takes ca. 20 sec, or the mutant D85,96N, with which the effect of dark adaptation observed with D96N does not occur and a constant proportion of the BR molecules are always involved in the photocycle. For many practical applications, D96N and D85,96N are to be regarded as equivalent, since the further photocycle of both mutants, apart from the different behavior as regards dark adaptation, does not differ.

The kinetics can also be altered through an alteration of the BR in a manner other than mutation, e.g. through the incorporation of artificial or modified amino acids or amino acid analogs into the peptide sequence, or through a chemical modification of the retinal. The term “BR variant” or “variants of a bacterial rhodopsin” is therefore to be understood below such that it comprises both mutants and BR molecules altered in another manner.

Application of PM Preparations by Printing Processes

PM preparations which are applicable by printing processes, e.g. by screen printing or gravure printing processes, have become known, such as for example from WO 00/59731. For this, the preparation is known of a so-called “switching powder” which can then be further processed into printing inks (see below).

In order to protect the BR completely from chemical changes, the further embedding of the “switching powder” in microcapsules (see e.g. WO-A-2010/124908) or enclosing of PM fragments in hybrid materials (see e.g. WO-A-2008/092628) are known. Thereby, the PM is essentially completely protected against outside influences.

A process has also become known in which BR in the PM is coated with a thin layer of waterglass in a biomimetic process (A. Schonafinger, S. Muller, F. Noll, N. Hampp, Bioinspired nanoencapsulation of purple membranes, Soft Matter, 2008, 4, 1249-1254). For this, firstly in a first step a polyelectrolyte (polyethyleneimine) is adsorbed exclusively on the charged surface, and then in a second step a waterglass layer is built up on this polyelectrolyte with the aid of TEOS. The systems thus formed have a layer of waterglass or an organically modified silicic acid (Ormocer) on the charged surface. This layer protects the bacteriorhodopsin in the purple membrane from the damaging influence of organic solvents, but the water glass or an organically modified silicic acid (Ormocer) introduced in corresponding manner is not completely impermeable. In particular, it lets small ions, in particular protons and hydroxide ions, through. The BR thus reacts just as before to changes in the pH-value of the environment.

Switching Powder

A BR-comprising color change pigment can be produced in a process described as follows.

Bacteriorhodopsin in the form of bacteriorhodopsin/purple membrane patches is suspended in an aqueous medium at a pH-value in the region of 6-9 in presence of a water-retaining polymer. This suspension is spray-dried to a powder or dried to a powder in an aliphatic solvent of low vapor pressure with subsequent solvent removal (e.g. water removal). A precursor capsule is as it were created thereby, in which the system bacteriorhodopsin/purple membrane is immobilized in a pH range suitable for its optical function. Just as before, the outer skin of this precursor capsule can be dissolved in water and allows the passage of small ions, in particular of oxonium and hydroxide ions. The powder consisting of these precursor capsules is also referred to as “switching powder”, because this powder already has stabilized optical properties of bacteriorhodopsin. It can be stably stored over a prolonged period.

During the production of the switching powder, the bacteriorhodopsin can be suspended in a buffer system, preferably selected from the following group: phosphate buffer, TRIS/HC1, ammonia buffer, carbonic acid/hydrogen carbonate system, diglycine, bicine, HEPPS, HEPES, HEPBS, TAPS, AMPD or a combination of such systems, preferably at a concentration of less than 0.03M, especially preferably at a concentration of less than 0.02M.

The bacteriorhodopsin can be present in the switching powder in the presence of a moisturizer, with this being preferably a mixture of potassium salt, preferably potash, with a sugar or sugar alcohol-based moisturizer, especially preferably a mixture of potash with xylitol or sorbitol, quite especially preferably in the ratio 1:2-2:1.

Preferably the bacteriorhodopsin is present in the water-retaining polymer in the form of bacteriorhodopsin/purple membrane patches in a proportion from 5 to 30 weight percent, preferably 10 to 20 weight percent, wherein the water-retaining polymer is preferably a system selected from the following group: gelatin, polyethylene glycol, acrylic acid-sodium acrylate copolymer, polyvinylpyrrolidone, polyvinyl alcohol, polysaccharides, gum Arabic, derivatized cellulose, glycogen, starch, sugar alcohols, derivatized chitin, xanthan, pectins, guar, locust bean gum, carrageen, superabsorbers, zeolites and combinations of respective mixtures of such water-retaining polymers.

Complete Encapsulation

When chemical influencing of the PM by the environment, in particular by neighboring layers, is not desired, the PM can in particular be present in microcapsules, as described in WO 2010/124908 A1.

In particular, it can in other words be a pigment based on optically switchable bacteriorhodopsin-comprising microcapsules with a diameter of less than 50 μm, preferably with a diameter less than 10 μm, with a covering layer which protects the bacteriorhodopsin from damaging environmental influences with simultaneous maintenance of function. In this, the bacteriorhodopsin is preferably embedded in the form of PM/BR patches in an aqueous medium at a pH-value in the region of 6-9 in the presence of a water-retaining polymer and this inner capsule is provided with a covering essentially completely transparent to light in the visible range consisting of a polymer and/or a long-chain saturated hydrocarbon and/or a long-chain saturated fatty acid, preferably a paraffin with a solidification point in the region of 45° C. -65° C. and/or a carnauba wax with a melting range from 70° C. -90° C.

Here, the covering layer protects not only against organic solvents and surfactants, but also to some extent against the pH-value or the proton availability of the environment. In other words, a defined pH-value is present in the microcapsule, which is essentially not influenced by the pH-value of the environment. It can thus be ensured that independently of the pH-value of the environment the microcapsule or the bacteriorhodopsin/purple membrane system enclosed therein has the desired optical properties. The microcapsules can also be referred to as pigments or color bodies.

Formulations for BR-Comprising Printing Inks

Preferably, the bacteriorhodopsin-color change pigment-comprising formulation is a formulation based on a water-dilutable, acrylic binder system, and/or based on a binder curable by a polymerization, in particular based on a thermally or UV light-initiated radical curing binder or based on an alkyd resin binder, preferably solvent-free long oil alkyd resin, whose polymerization is triggered with atmospheric oxygen. Optionally a rheological additive, a surfactant and/or a dispersant can be added. In addition, additives can be added to the formulation in order to influence a neighboring retinal protein-comprising color layer after application. This can occur through adjustment of the pH-value in the formulation, or by addition of agents such as hygroscopic substances.

In general, the formulation preferably has a viscosity in the region of 0.01 to 100 Pa s. The stated viscosity values relate to a temperature of 20° C. More preferably, the viscosity is adjusted for the particular printing process used, preferably for flexo printing in the region of 0.05-0.5 Pa s, for offset (flatbed printing) in the region of 40-100 Pa s, for gravure printing in the region of 0.05-0.2 Pa s, for screen printing in the region of 0.5-2, preferably in the region of 1 Pa s, and for inkjet printing in the region of 0.01 to 0.05 Pa s.

Preferably, the formulation also has a surface tension of less than 40 mN/m.

In general, the color change pigment is preferably present in the formulation in a content by weight in the region of 1-67 weight %, and particularly preferably in the region of 10-55 weight % in the formulation.

Suitable binder systems are made up in the usual manner known to those skilled in the art.

Formulations for Functional Layers

Formulations for functional layers for influencing BR-comprising color layer can be produced in the same manner as the actual printing inks, in particular on the basis of a water-dilutable, acrylic binder system, and/or on the basis of a radical-curing binders, in particular on the basis of a UV-initiated, radical UV-curing binder and on the basis of an alkyd resin binder (preferably long oil alkyd), optionally a rheological additive, optionally a surfactant and/or optionally a dispersant. In the process, additives can be added to the formulation in order to influence a neighboring retinal protein-comprising color layer after application. This can be effected by adjustment of the pH-value in the formulation, or by addition of moisture-influencing agents such as hygroscopic substances.

As substances which influence the pH-value in the formulation, the following may non-exhaustively be mentioned: buffer systems such as TRIS/HC1(with TRIS: tris(hydroxymethyl)-aminomethane), the ampholytic buffers HEPES (4-(2-hydroxyethyl)-1-piperazinethanesulfonic acid), HEPPS (4-(2-hydroxyethyl)-piperazin-l-propanesulfonic acid), MES (brand name PUFFERAN™ equals 2-(N-morpholino)ethanesulfonic acid), amino acids or Na2HPO4/NaH2PO4 or ion exchange resins such as LEWATIT™ (from Lanxess), Dowex™ (from Dow Chemicals) or Amberlite™ (from Rohm and Haas). A whole range of further substances influencing the pH are known to those skilled in the art and are common prior art. As examples of hygroscopic substances, the following may non-exhaustively be mentioned: lithium and potassium salts (such as halides or phosphates thereof) magnesium silicates, sugars, sugar alcohols (such as xylitol or sorbitol), poly-dextroses, glycerin and low molecular or polymeric glycols (such as 1,2-propanediol).

Examples of Water-Dilutable, Acrylic Binder Systems

Such systems are typically made up of a film-forming agent, a dispersant, surfactant, rheological additives (optional) and the actual pigment.

Film-forming agents: quick-drying acrylate dispersion, e.g. Acronal LR 8820 (BASF) or Joncryl 354 (Johnson Polymer) or related types

Dispersants/surfactants: Selection depending on use purpose and printing process, e.g. Dynwet 800 (Byk), Disperbyk 168 (Byk), Disperbyk 182 (Byk), Zonyl FSN (DuPont), BRIJ types (Merck), Dispersb 650 (Tego) or Dispers 755W (Tego)

Rheological additives: Aerosil types (Degussa-Hüls), Cab-O-sil types (Cabot)

Colored bodies: “switching powder”, further neutral pigments and/or neutral colored bodies to produce desired decorative effects (e.g. the phthalocyanine PB 15:2)

Examples of UV-Curable Binders:

Such systems are typically made up of a film-forming agent, a reactive diluent, a radical starter, a surfactant, rheological additives (optional), defoamants (optional) and the colored body pigment.

Film-forming agents: from the very large possible choice of UV-crosslinkable film-forming agents (acrylated polyesters, urethanes and epoxy resins), the following are selected by way of example: HEMA-TMDI, various manufacturers or other bisphenol A derivatives

Reactive diluents: by way of example and not exclusively: HDDA, DPGDA, TPGDA

Radical starters: a combination of 2-hydroxy-2-methyl-1-phenyl-propan-1-one (e.g. Darocur 1173(Ciba)) with benzophenone (various manufacturers) and acylphosphine oxide photoinitiators (e.g. Lucirin TPO (BASF)) has proved effective.

Surfactants: Dynwet types (Byk), Zonyl types (DuPont), BRIJ types (Merck), Surfynol types (Air Products)

Rheological additives: Aerosil types (Degussa-Huls), Cab-O-sil types (Cabot)

Colored body: “switching powder”, further neutral pigments and/or neutral colored bodies for producing desired decorative effects (e.g. the phthalocyanine PB 15:2)

Examples of a Cationic UV-Curable Binder:

Such systems are typically made up of a film-forming agent, a starter combination, a surfactant, rheological additives (optional) and the colored body pigment.

Film-forming agents: bis-vinyl ether monomers or cycloaliphatic epoxides in combination with reactive acrylates such as HEMA-TMDI or other bisphenol A derivatives

Starter combinations: the combination of a cationic starter with radical-acting starters is known to those skilled in the art. The choice of cationic starters is quite limited and dependent on the individual case (substrate, machines, emitter used). Cationic starters fall into one of the following three substance classes: diaryliodonium salts, triarylsulfonium salts or ferrocenium salts, with ferrocenium salts being less preferable in the present application.

Surfactants: Dynwet types (Byk), Zonyl types (DuPont), BRIJ types (Merck), Surfynol types (Air Products)

Rheological additives: Aerosil types (Degussa-Hills), Cab-O-sil types (Cabot)

Colored bodies: “switching powder”, further neutral pigments and/or neutral colored bodies for producing desired decorative effects (e.g. the phthalocyanine PB 15:2)

The opacity of the layers is adjusted between semitransparent and completely opaque by means of suitable additives such as are known to those skilled in the art and usual in graphic chemistry.

Example: Influence of the Layer Thickness on the Relaxation Time

A printed product was produced by applying five equally dimensioned color strips with different layer structures onto a common substrate. The color strips consisted of one single layer and two, three, four and five layers respectively of the same printing ink, which comprised the variant BR-D96N. Coated cardboard was used as the substrate. A UV-curing formulation from Actilor was used as the printing ink. This comprised “switching powder” based on BR-D96N. The “switching powder” was present in a radical UV-curing binder system based on BR-D96N, embedded in a matrix of polysaccharide and moisture-retaining and pH controllable additives. The ink was applied by screen printing at 190 lines/cm. Each layer was solidified (“dried”) with the UV light usual in the printing industry from a medium pressure Hg lamp in the form of a UV belt dryer with an irradiation energy of 450 mJ/cm², before the respective next layer was applied. For each individual layer, the volume applied per unit area was 5 cm³/m², corresponding to an average layer thickness of ca. 20 micrometers per layer (value estimated).

The printed product was firstly conditioned for one hour by intensive illumination with a normal commercial incandescent lamp. During this a part of the product was opaquely covered. Directly after the end of the illumination, the printing ink in the exposed part of the printed product had acquired the characteristic yellow coloration of the M state, while the covered part exhibited the characteristic violet coloration of the ground state. The relaxation of the exposed part was now observed under weak, diffuse light (daylight with overcast sky), by visually assessing the color contrast between the illuminated part and the exposed part in each of the five strips at regular time intervals. During this it was observed that the color contrast between the illuminated and the exposed part persisted longer the more layers were present in the corresponding strip, which is equivalent to a thicker layer.

Example: Influencing the Time Dependence via Functional Layers

An aqueous acrylate dispersion (Neocryl™ A1131 (DSM NeoResins)) was adjusted to a pH between 7 and 9 with a phosphate buffer and homogeneously treated with “switching powder” based on BR-D96N-PM so that the PM content by weight in the dried preparation was ca. 20%.

This PM preparation was applied onto rag paper as substrate in a known manner and dried.

A further, largely transparent layer of a dried aqueous acrylate suspension (Neocryl™ A1131) was applied onto the substrate thus coated. While still an aqueous dispersion, this layer had been adjusted to a pH which markedly differed from the PM preparation-comprising layer lying thereunder.

When the layer laid over it was adjusted to be more acidic than the layer comprising the PM preparation, the proton availability in the PM preparation was increased and both the color change on illumination and also the relaxation accelerated. If on the other hand the layer laid over it was more alkaline than the PM preparation, a slowed color change and a slower relaxation, respectively, resulted.

Thus by application of differently adjusted layers in different surface elements, the time dependence of the color change could be spatially modulated.

1. A product, comprising:
a substrate; and
a color application applied thereon, wherein the color application in each of a first and a second surface element has at least one color layer comprising a retinal protein which exhibits a color change on illumination,
wherein in at least one of the surface elements at least one functional layer is present which alters the proton availability for the retinal protein in the surface element concerned, so that the color change of the retinal protein in the first and in the second surface element exhibits at least one of a different time dependence and/or light sensitivity.

2. The product as claimed in claim 1, wherein the first and the second surface element comprise the same formulation of the retinal protein.

3. The product as claimed in claim 2, wherein the formulation is constituted as follows: retinal protein in powder form, film-forming binder as physically drying or UV-curable dispersion or as UV-curable 100%-system, surfactants, hygroscopic additives and at least one of acidic and alkaline and amphoteric additives in a quantity ratio which forms a buffer system in dilute aqueous solution.

4. The product as claimed in claim 1, wherein the retinal protein is bacteriorhodopsin or a bacteriorhodopsin variant.

5. The product as claimed in claim 1, wherein the first and the second surface element have different thicknesses or numbers of functional layers which alter the proton availability for the retinal protein.

6. The product as claimed in claim 1, wherein in at least one of the surface elements the functional layer is arranged between the substrate and the at least one color layer.

7. The product as claimed in claim 1, wherein in at least one of the surface elements the functional layer is arranged on the side of the at least one color layer facing away from the substrate.

8. The product as claimed in claim 1, wherein in at least one of the surface elements a functional layer is arranged both between the substrate and the at least one color layer and also on the side of the at least one color layer facing away from the substrate.

9. The product as claimed in claim 1, wherein in at least one of the surface elements the functional layer alters the proton availability for the retinal protein depending on a chemical environment of the product.

10. The product as claimed in claim 1, wherein the functional layer comprises at least one of the following substances modulating the proton availability: buffer systems, amino acids, and ion exchange resins.

11. The product as claimed in claim 1, wherein the functional layer comprises at least one water-retaining substance.

12. The product as claimed in claim 11, wherein the functional layer has a film-forming agent as matrix for the water-retaining substance, in order to immobilize the water-retaining substance.

13. The product as claimed in claim 1,
wherein the color change in the first surface element occurs with a first time dependence,
wherein the color change in the second surface element occurs with a second time dependence,
wherein the color application in addition has at least one third surface element, in which the color change occurs with a third time dependence,
wherein the first time dependence has a first characteristic time constant, wherein the second time dependence has a second characteristic time constant, and wherein the third time dependence has a third characteristic time constant,
wherein the third characteristic time constant is greater than the second characteristic time constant and the second characteristic time constant is greater than the first characteristic time constant, and
wherein the first, second and third surface element are spatially arranged relative to one another in such a manner that on illumination the impression is created of a color change migrating spatially from the first via the second to the third region.

14. A security related product, having a security element in the form of a product comprising:
a substrate; and
a color application applied thereon, wherein the color application in each of a first and a second surface element has at least one color layer comprising a retinal protein which exhibits a color change on illumination, in at least one of the surface elements at least one functional layer being present which alters the proton availability for the retinal protein in the surface element concerned, so that the color change of the retinal protein in the first and in the second surface element exhibits at least one of a different time dependence and light sensitivity,
wherein the security-related product is selected from the following list: identification papers, passports, ID cards, visas, banknotes, tax stamps, postage stamps, stock certificates, tickets, seals, forms, labels for product identification, labels for brand identification, laminating films and transfer films.

15. A process for production of a product, comprising:
application of a color application onto a substrate, wherein the color application in each of a first and in a second surface element has at least one color layer comprising a retinal protein which exhibits a color change on illumination,
wherein in at least one of the surface elements at least one of before and/or after the color application at least one functional layer is applied which alters the proton availability for the retinal protein in the surface element concerned, so that the color change of the retinal protein in the first and in the second surface element exhibits at least one of a different time dependence and/or light sensitivity.

16. The process as claimed in claim 15, wherein in the first and second surface element the same formulation of the retinal protein is applied.

17. The process as claimed in claim 15, wherein the application of at least one of the color application and/or the functional layer is effected with one of the following methods: gravure printing, intaglio printing, screen printing, inkjet printing, waterless offset, flexo printing, and letterpress printing.

18. The product as claimed in claim 3, wherein the film-forming binder is acrylate-based or polyurethane-based.

19. The product as claimed in claim 3, wherein the formulation comprises further colorants.

20. The product as claimed in claim 3, wherein the formulation comprises further additives such as photostabilizers and at least one of rheological additives and biostabilizers.

21. The product as claimed in claim 10, wherein the buffer systems comprise at least one of TRIS/HC1, HEPES, HEPPS, MES and Na₂HPO₄/NaH₂PO₄.

22. The product as claimed in claim 11, wherein the at least one water-retaining substance is selected from the following group: salts which retain water as water of crystallization, unmodified or partly modified polyalcohols, oligo-alcohols, polydextroses, glycerin, low molecular or polymeric glycols, superabsorbers, zeolites, organic resins modified by acidic or basic groups.

23. The product as claimed in claim 22, wherein the partly modified polyalcohols comprise partly esterified polyalcohols.

24. The product as claimed in claim 22, wherein the oligo-alcohols comprise sugars and sugar alcohols.

25. The product as claimed in claim 22, wherein the organic resins comprise ion exchange resins.

26. The product as claimed in claim 12, wherein the film-forming agent is selected from the following group: aqueous acrylate dispersions, aqueous polyurethane dispersions, UV-curable acrylate resins, and oxidatively drying alkyd resins.
